(19) United States
(12) Patent Application Publication
(10) Pub. No.: US 2021/0387245 A1
(43) Pub. Date: Dec. 16, 2021

(54) STAMPING TOOL COMPRISING AN UPPER TOOL BODY AND A LOWER TOOL BODY ARRANGED AT A DISTANCE FROM THE UPPER TOOL BODY

(71) Applicant: Ehrt Maschinenbau GmbH, Rheinbreitbach (DE)

(72) Inventor: Andreas Winters, Rheinbreitbach (DE)

(21) Appl. No.: 17/287,484

(22) PCT Filed: Oct. 22, 2019
(86) PCT No.: PCT/EP2019/078645

§ 371 Date: Apr. 21, 2021

(30) Foreign Application Priority Data
Oct. 22, 2018 (DE) 10 2018 126 195.0
Apr. 17, 2019 (DE) 10 2019 110 164.6

(51) Int. Cl. B21D 28/12; B21D 28/34; B21D 37/12; B26F 1/44

(52) U.S. Cl. CPC B21D 28/125; B21D 28/34; B26F 2001/4454; B26F 1/44; B21D 37/12

(57) ABSTRACT

The invention concerns a stamping tool with a tool upper body, a tool lower body arranged separately from the tool upper body, at least one stamping unit and a guide axis arranged centrally which extends partly through the tool upper body and the tool lower body, wherein the tool upper body is movable relative to the tool upper body and the guide axis guides the movement of the tool upper body.

The invention concerns a stamping tool and a processing machine for processing a workpiece with this type of stamping tool.

A large number of differently designed stamping tools are known from prior art. The stamping tools have a stamping unit by means of which the workpiece to be processed is stamped. Furthermore, stamping tools have a tool upper body and a tool lower body.

In a stamping process, the movement of the tool upper body relative to the tool lower body must be guided precisely to enable the processing machine to have a long service life. However, it is not always possible to ensure that the guiding is precise, resulting in short service lives.

One task of this invention is to offer a stamping tool by means of which a long service life can be achieved.

The task is achieved by a stamping tool with a tool upper body, a tool lower body arranged apart from the tool upper body, at least one stamping unit and a guide axis arranged centrally which extends partly through the tool upper body and the tool lower body wherein the tool upper body can be moved relative to the tool lower body and the guide axis guides the movement of the tool upper body.

The stamping tool according to the invention has the advantage that the guidance of the tool upper body can be realised very precisely by the centrally arranged guide axis. This increases the service life of the stamping tool. Furthermore, it is possible with the stamping tool according to the invention that workpieces for instance, in particular copper workpieces, with a thickness of 20 mm can be stamped.

In the case of a special design, the stamping tool can have at least two bolts. The bolts can be arranged eccentrically and/or extend partly through the tool upper body and the tool lower body. The provision of the bolts is an easy way of preventing the tool upper body from turning relative to the tool lower body.

The bolts can be arranged radially if the normal axial cross section of the tool upper body and/or the tool lower body is circular in shape. In particular, the bolts can be displaced radially from a central axis of the stamping tool. This means that each of the bolts can be arranged in an area at a radial distance from the central axis of the stamping tool. Additionally, the bolts can be arranged around the circumference of the tool upper body and/or of the tool lower body, the bolts being separated with a gap between each other. In particular, the bolts can be arranged such that each middle point of the bolts can be arranged on a circumference with a gap between each other.

In the case of a special design, one end of the bolt can be attached, in particular detachably, with a slot nut. In particular, the end of the bolt can be screwed into the slot nut. The slot nut can be arranged in a recess of the tool lower body wherein some play exists between the slot nut and a wall adjacent to the recess. Due to the slot nut and the play between the slot nut, jamming of the bolt can be prevented easily when assembling the stamping tools. This is possible because, due to the play, a misalignment between, for example, the thread of the slot nut and a bushing can be offset. The bushing can be arranged in the tool upper body. The bolt can extend right through the bushing wherein the bushing connected solidly with the bolt can be moved relative to the bolt. This ensures that, during a stamping process, the bolt does not move together with the tool upper body but instead remains stationary.

One end of a spring can be supported on an end of the bolt furthest away from the slot nut. This offers the advantage that, when the tool upper body is retracted after a stamping operation, it is prevented from assuming a starting position where the head of a bolt is damaged by the original tool. The spring can be supported on another end on the bushing.

In the case of a particular design, the guide axis can be solidly connected to the tool upper body. The solid connection can be realised, for example, by a screw connection. Furthermore, the guide axis can be movable relative to the tool lower body. The tool lower body can have a seating in which the guide axis is arranged and in which it can be moved in the stamping operation.

The tool upper body and the tool lower body can be arranged coaxially to one another. Furthermore, the guide axis can be arranged coaxially to the tool upper body and the tool lower body. This arrangement results in an especially compact stamping tool.

In another design, the tool lower body can guide the stamping unit. In this arrangement, the stamping unit can be guided in a simple manner.

The stamping unit can be arranged eccentrically and/or axially offset to the guide axis. In particular, a longitudinal axis of the stamping unit can run parallel to a central axis of the stamping tool, especially to a longitudinal axis of the guide axis.

The stamping tool can have several stamping units, in particular exactly six stamping units. The stamping units can be arranged circumferentially around the tool upper body and/or of the tool lower body separated from each other. In this system, the central points of the stamping units can be arranged along a circular line separated from each other. In this design, the stamping units are arranged as in a revolver. The guide axis can be arranged in the space enclosed by the circular line.

In a particular design, the stamping unit can have a stamping die and a stamping punch designed separately from the stamping die. In a stamping operation, the stamping punch exerts a compressive force on the stamping die. As a result of the compressive force, the stamping die is moved out of the tool lower body so that the stamping process can be carried out. The stamping die and the stamping punch can be arranged together so that they are coaxial.

An actuator on the processing machine can cause the stamping units to move. The actuator performs a displacement movement which causes the stamping unit to move. The actuator can have, for example, a hydraulic cylinder. In this system, one stamping unit or several stamping units can be operated. Alternatively it is possible that the actuator works all stamping units simultaneously. In this case, the workpiece is stamped simultaneously by all stamping units.

The stamping tool can have another spring. The other spring is supported at one end on the stamping punch and at one end with the tool upper body. In a stamping operation, the other spring is tensioned. Here, another spring can be allocated to each stamping unit of the stamping tool. In a stamping operation where, for example, only one stamping unit stamps the workpiece, the other spring acts so as to force the stamping punch of the stamping unit, which is not stamping the workpiece, towards the workpiece. This is a simple way of preventing the end furthest from the stamping die from protruding out of the tool upper body.

The stamping die can have a T-shaped stamping head. The T-shaped stamping head is arranged in a seating of the tool upper body. During a stamping operation, the T-shaped stamping head exerts a force on the tool upper body towards the workpiece due to the especially positive-locking connection with the tool upper body.

In one particular design, the tool lower body can have a base plate which has at least one, in particular several, strippers. The stripper can be arranged in a recess in the base plate. The stripper can guide the stamping unit. Furthermore, after a stamping operation, the stripper prevents the workpiece together with the stamping unit from moving in the reverse direction of the stamping unit. Furthermore, the stripper can remove any contamination on the stamping after the stamping operation before the stamping die is retracted into the tool lower body and/or the base plate.

The stripper can be connected non-rotatably to the stamping unit. Furthermore, the stripper can be connected non-rotatably with the base plate. By so doing, this simply ensures that the rotation of the stamping unit relative to the tool upper body and/or to the tool lower body is prevented. This is of particular advantage in the case of stamping units which have an angular shape in a cross section normal to its axis.

A processing machine is particularly advantageous where a workpiece is processed with a tool holder in which a stamping tool according to the invention is arranged.

The stamping tool is not screwed to the workpiece receptacle. During the stamping operation, the stamping tool is moved towards the workpiece. In doing so, the tool holder serves as a guide for the stamping tool.

In the Figures the subject matter of the invention is illustrated diagrammatically, wherein identical elements, or elements with the same effect, are mostly provided with the same reference symbols. They show, in:

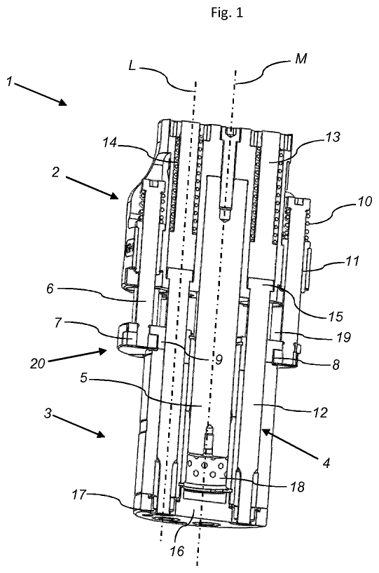

FIG. 1 a lateral cross section of the stamping tool according to the invention,

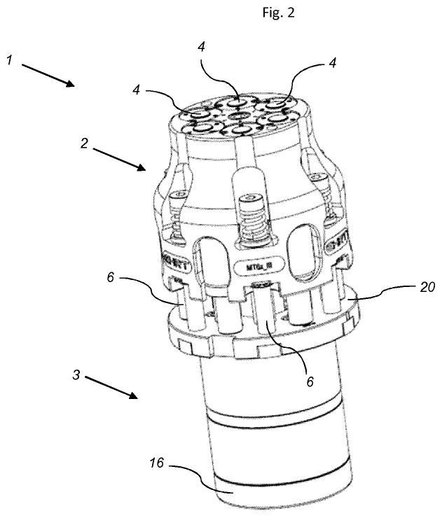

FIG. 2 a perspective view of the stamping tool shown in FIG. 1.

FIG. 1 shows a lateral cross section of a stamping tool 1 according to the invention for stamping a workpiece not shown in the Figures. The stamping tool 1 has a tool upper body 2, a tool lower body 3 arranged with a gap from the tool upper body 2, several stamping units 4 and a guide axis 5 arranged centrally. In particular the guide axis 5 runs coaxially to a central axis M of the stamping tool 1. The guide axis 5 extends partly through the tool upper body 2 and the tool lower body 3. The tool upper body 2 can be moved relative to the tool lower body 3 and the guide axis 5 guides the movement of the tool upper body 2. In this arrangement, in a stamping operation, the tool upper body 2 is moved towards the tool lower body 3.

With the stamping tool 1 idle, the guide axis 5 also extends through an intermediate space 19 located between the tool upper body 2 and the tool lower body 3. The guide axis 5 is solidly attached, though again releasable in particular, to the tool upper body 2. The solid attachment is achieved by means of a screw connection. The tool lower body 3 has a receptacle 18 to accommodate the guide axis 5. When the tool upper body 2 moves towards the tool lower body 3, the guide axis 5 is moved inside the receptacle 18.

The tool upper body 2 and the tool lower body 3 are arranged coaxially to one another. Furthermore the guide axis 5 is arranged coaxially to the tool upper body 2 and tool lower body 3.

The stamping tool 1 has several bolts 6 arranged eccentrically. The bolts 6 are arranged to be axially offset to the guide axis 5 and run parallel to it. One end of the bolt 6 is solidly connected with a slot nut 7. The solid connection is realised by a screw connection. The slot nut 7 is arranged in a recess 8 in the tool lower body 3. The recess 8 is arranged in a radially projecting flange 20 on the tool lower body 3.

The slot nut 7 and the recess 8 are dimensioned such that there is play between the slot nut 7 and a wall 9 defined by recess 8. In particular there is play between the wall 9 of the recess 8 and the slot nut 7 in the radial direction. Thus, during assembly of the stamping tools 1, the bolt 6 does not become jammed. In the axial direction of the stamping tool 1, that is, in the direction along the central axis M, the slot nut 7 pushes against the recess 8 defining wall 9 of the flange of the tool lower body 2.

The bolt 6 extends through a bushing 11. The bushing 11 is arranged in the tool upper body 2 and is connected solidly with the tool upper body 2. During a stamping operation, the tool upper body 2 moves relative to the bolt 6. A force is exerted thereby on a spring 10 which is supported at one end on the bolt 6 and at another end on the bushing 11.

The stamping unit 4 has a stamping punch 13 in the form of a plunger and a stamping die 12. The stamping punch 13 is in direct contact with the stamping die 12, in particular at a T-shaped stamping die head 15.

The stamping punch 13 and the stamping die head 15 are arranged in a recess in the tool upper body 2. The remaining part of the stamping die 12 of the stamping die head 15 is arranged in the intermediate space and another recess in the tool lower body 3. Thus in a stamping process, the tool lower body 3 serves to guide the stamping units 4, particularly the stamping die 12.

In addition to the stamping punch 13, another spring 14 is also arranged in the recess of the tool upper body 2. The other spring 14 is supported at one end on the stamping punch 13 and, at another end, on the tool upper body 2. During a stamping operation by one of the stamping units, the other spring 14 is tensioned. Each of the stamping units 4 of the stamping tool 1 is designed identically, as described above.

On its end away from the tool upper body 2, the tool lower body 3 has a base plate 16. The base plate 16 has openings in each of which a stripper 17 is arranged. The stripper 17 serves to guide the stamping unit 4, in particular the stamping die 12. Furthermore, the stripper 17 prevents the situation where, during a stamping operation, the workpiece not illustrated in the Figures, together with the stamping unit 4, in particular with the stamping die 12, is moved together to a starting position when the stamping unit 4 withdraws. Also, the stripper 17 prevents contamination remaining on the stamping die 12 and therefore entering the stamping tool 1.

FIG. 2 shows a perspective view of the stamping tool 1 shown in FIG. 1. As can be seen in FIG. 2, the tool upper body 2 and the tool lower body 3 each have an essentially round shape in cross section.

The stamping tool 1 has six stamping units 4 with are designed as in a revolver. This indicates that the individual stamping units 4 are arranged along a circular line with a gap between each other. In doing so, the stamping units 4 are eccentric, that is, arranged radially separated from the central axis M of the stamping tool. The guide axis 5 is arranged in the area enclosed by the circular line.

It can also be taken from FIG. 2 that the stamping tool 1 has several bolts 6 which are arranged along the circumference of the tool upper body 2 and/or of the tool lower body 3 with a gap in between each other.

### LIST OF REFERENCES

1 Stamping tool
2 Tool upper body
3 Tool lower body
4 Stamping unit
5 Guide axis
6 Bolt
7 Slot nut
8 Recess
9 Wall
10 Spring
11 Bushing
12 Stamping die
13 Stamping punch
14 Other spring
15 Stamping head
16 Base plate
17 Stripper
18 Receptacle
19 Intermediate space
20 Flange
M Central axis
L Longitudinal axis of the stamping unit

1. (canceled)

1. Stamping tool with a tool upper body, a tool lower body arranged separately from the tool upper body, at least one stamping unit and a guide axis arranged centrally which extends partly through the tool upper body and the tool lower body, wherein the tool upper body is movable relative to the tool lower body and the guide axis guides the movement of the tool upper body.

2. Stamping tool according to claim 1 characterised by at least two bolts which are arranged eccentrically and/or extend partly through the tool upper body and the tool lower body.

3. Stamping tool according to claim 2, characterised in that a cross section of the tool upper body and/or the tool lower body is circular with respect to its normal axis and the bolts are arranged radially.

4. Stamping tool according to claim 2, characterised in that the bolts are arranged along a circumference of the tool upper body and/or of the tool lower body with a gap between each.

5. Stamping tool according to claim 2, characterised in that one end of the bolt is connected to a slot nut.

6. Stamping tool according to claim 5, characterised in that the slot nut is arranged in a recess of the tool lower body wherein there is play between the slot nut and a wall adjoining the recess.

7. Stamping tool according to claim 2, characterised by
a. a spring which is supported at one end at the end of the bolt away from the slot nut and/or
b. a bushing arranged in the tool upper body through which the bolt extends.

8. Stamping tool according to claim 1, characterised in that
a. the guide axis is connected solidly to the tool upper body and/or that
b. the guide axis can be moved relative to the tool lower body.

9. Stamping tool according to claim 1, characterised in that
a. the tool upper body and the tool lower body are arranged coaxially to one another and/or that
b. the tool lower body guides the stamping unit.

10. Stamping tool according to claim 1, characterised in that the stamping unit is arranged so that it is offset with respect to the guide axis.

11. Stamping tool according to claim 1, characterised in that the stamping unit has a stamping die and a stamping punch designed separately from the stamping die, wherein
a. during a stamping process, the stamping punch exerts a compressive force on the stamping die and/or wherein
b. during the stamping process, the stamping punch tensions another spring.

12. Stamping tool according to claim 11, characterised in that the stamping die has a T-shaped stamping head.

13. Stamping tool according to claim 1, characterised in that the tool lower body has a base plate which houses at least one stripper.

14. Stamping tool according to claim 13, characterised in that the stripper is connected non-rotatably with the stamping unit, in particular with the stamping die.

15. Processing machine for the processing of a workpiece and having a tool receptacle in which a stamping tool according to any one of claims 1 to 14 is arranged.
